(19) United States
(12) Patent Application Publication
(10) Pub. No.: US 2007/0176855 A1
(43) Pub. Date: Aug. 2, 2007

(54) DIAGNOSTIC/PROTECTIVE HIGH VOLTAGE GATE DRIVER IC (HVIC) FOR PDP

(75) Inventor: Dong Young Lee, Torrance, CA (US)

Correspondence Address: OSTROLENK FABER GERB & SOFFEN, 1180 AVENUE OF THE AMERICAS, NEW YORK, NY, 100368403, US

(73) Assignee: INTERNATIONAL RECTIFIER CORPORATION, El Segundo, CA (US)

(21) Appl. No.: 11/668,077

(22) Filed: Jan. 29, 2007

Related U.S. Application Data
(60) Provisional application No. 60/763,545, filed on Jan. 31, 2006.

(51) Int. Cl. G09G 3/28

(52) U.S. Cl. 345/60

(57) ABSTRACT

A PDP sustain driver circuit including at least one high voltage gate driver IC (HVIC) having internal logic functions. The PDP sustain driver circuit including a plurality of switches, the HVIC providing a unique control signal to at least one first and at least one second switch. The internal logic functions including a sensing circuit for sensing information about the at least one second switch; and a reporting circuit for reporting or displaying a signal indicating at least one of a plurality of failure modes of the at least one second switch.

### CROSS-REFERENCE TO RELATED APPLICATION

This application is based on and claims priority to U.S. Provisional Patent Application Ser. No. 60/763,545, filed on Jan. 31, 2006 and entitled DIAGNOSTIC/PROTECTIVE HIGH VOLTAGE GATE DRIVER IC (HVIC) FOR PDP, the entire contents of which are hereby incorporated by reference herein.

### BACKGROUND OF THE INVENTION

The present invention relates to a Plasma Display Panel (PDP) high voltage gate driver IC (HVIC) and more particularly to a PDP HVIC that includes an internal diagnostic and protective function block for a sustain driver.

PDP HVICs include an internal logic functional block for a PDP sustain driver. A PDP sustain driver is an example of capacitive load half-bridge driver with soft switching. An internal diagnostic and protective function block makes debugging system failures easier and prevents system damage and product liability accidents, e.g., overheating, fires, fumes, and explosion.

FIG. 1 shows a conventional PDP sustain driver 10, which is a half-bridge driver with soft switching for a capacitive load. The PDP sustain driver 10 consists of four switches, including a rising switch 12, a falling switch 14, a sustain switch 16, and a ground switch 18. The PDP sustain driver 10 further includes a capacitors 20; diodes 24 and 26 and an inductor 28. Capacitor 22 represents the capacitance Cₚ of the PDP itself.

The switch 16 has one end connected to a power supply terminal (not shown); the switch 18 has one end connected to the ground terminal; the other ends of the switches 16 and 18 are interconnected at a node A. The node A is connected to a plurality of sustain electrodes represented in FIG. 1 as a panel capacitance Cₚ 22 corresponding to the total capacitance between the plurality of sustain electrodes and the ground terminal.

The switch 12 and the diode 24 are series connected between the node B and the recovering capacitor Cᵣ 20 that is also connected to the ground terminal. The diode 26 and switch 14 are similarly connected in series between the node B and the recovering capacitor Cᵣ 20.

When the control signal to the switch 18 attains a low level, the switch 18 turns off, while when the control signal to the switch 12 attains a high level, the switch 12 turns on. At the time, the control signal to the switch 16 is at a low level, and the switch 16 is in an off state, while the control signal to the switch 14 is at a low level, and the switch 14 is in an off state. Therefore, the recovering capacitor Cᵣ 20 is connected to the recovering coil 28 through the switch 12 and the diode 24, and LC resonance by the recovering coil 24 and the panel capacitance Cₚ 22 causes the voltage at the node A to gradually rise. At the time, charges from the recovering capacitor Cᵣ 20 are discharged to the panel capacitance Cₚ 22 through the switch 12, the diode 24 and the recovering coil 28.

A conventional sustain driver 10 requires four input signals. The four input signals are connected to gates of each of the switches 12, 14, 16, and 18, each signal driving a unique switch. FIG. 2 shows a conventional sustain driver 30 that uses four input signals, it includes four switches 12, 14, 16, and 18; capacitor 20; the PDP capacitance 22; diodes 24 and 26 and an inductor 28. The driver 30 further includes a signal buffer 36 and two HVICs 32 and 34. The signal buffer 36 receives four signals, a signal ERR for the rising switch 12, a signal SUS for the sustain switch 16, a signal ERF for the falling switch 14, and a signal GRND for a ground switch 12. The HVIC 32 is connected to and controls the rising switch 12 and the sustain switch 16. The HVIC 34 is connected to and controls the falling switch 14 and the ground switch 18. Accordingly, each switch 12, 14, 16, and 18 is independently controlled. This, however, commands high cost and space for a four input signal printed circuit board (PCB) pattern, as well as multiple cables from a timing controller and the signal buffer 36.

The prior art uses common or generally known gate driver HVIC designs to drive switches without diagnostic and protective functions, and can drive each switch 12, 14, 16, and 18 independently. However, without diagnostic and protective functions, system damage and accidents cannot be prevented. Further, system failure modes cannot be reported. What is needed is a novel HVIC design that includes diagnostic and protective functions.

### SUMMARY OF THE INVENTION

It is an object of the present invention to provide a system to make debugging system failures easy and prevents system damage and product liability accidents.

The invention comprises a PDP sustain driver circuit including at least one high voltage gate driver IC (HVIC) having internal logic functions. The PDP sustain driver circuit includes a plurality of switches, the HVIC providing a unique control signal to at least one first and at least one second switch. The internal logic functions including a sensing circuit for sensing information about the at least one second switch; and a reporting circuit for reporting or displaying a signal indicating at least one of a plurality of failure modes of the at least one second switch.

The internal logic functions further include an estimating circuit for receiving the sensed information and estimating a failure condition; a diagnosing circuit for receiving the sensed information and the estimated failure condition and diagnosing the at least one failure mode; and a protection circuit for commanding the gate driver to shut-down or self restart in accordance with the failure mode, wherein the diagnosing circuit alerts the reporting and protection circuits to report or display the failure mode and to issue the shut-down or self restart commands.

Other features and advantages of the present invention will become apparent from the following description of the invention that refers to the accompanying drawings.

### BRIEF DESCRIPTION OF THE DRAWINGS

FIG. 1 is a schematic diagram of a conventional PDP sustain driver

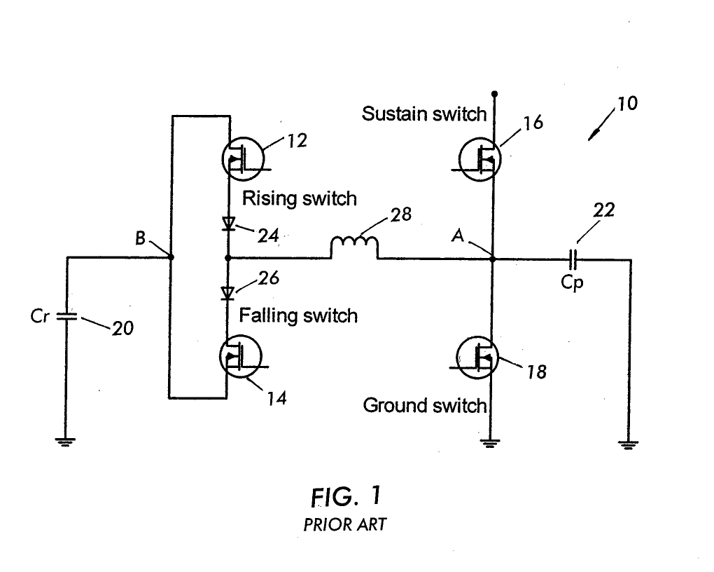

FIG. 2 is a schematic diagram of the conventional PDP sustain driver of FIG. 1 having four inputs connected to switch gates;

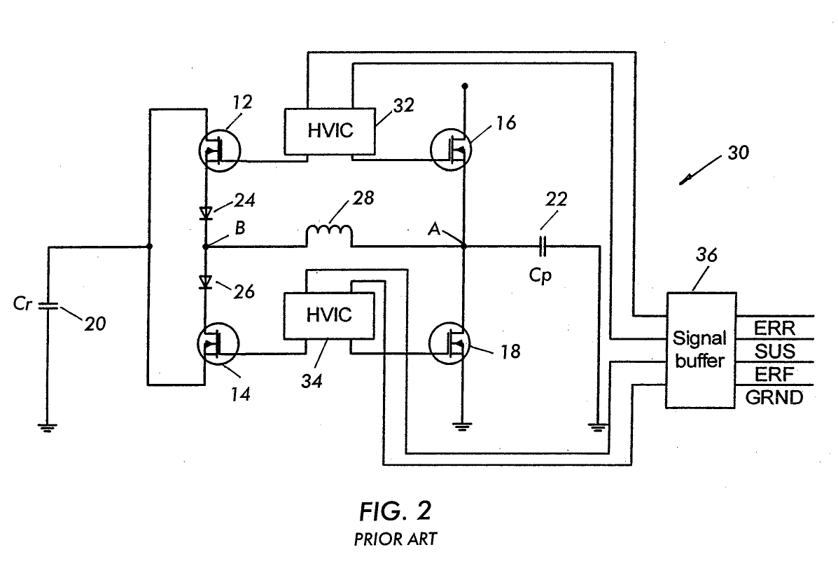

FIG. 3 is a schematic diagram of a PDP sustain driver that uses an HVIC that reports display failure modes; and

FIG. 4 is a block diagram of the HVIC of FIG. 3.

### DETAILED DESCRIPTION OF EMBODIMENTS OF THE INVENTION

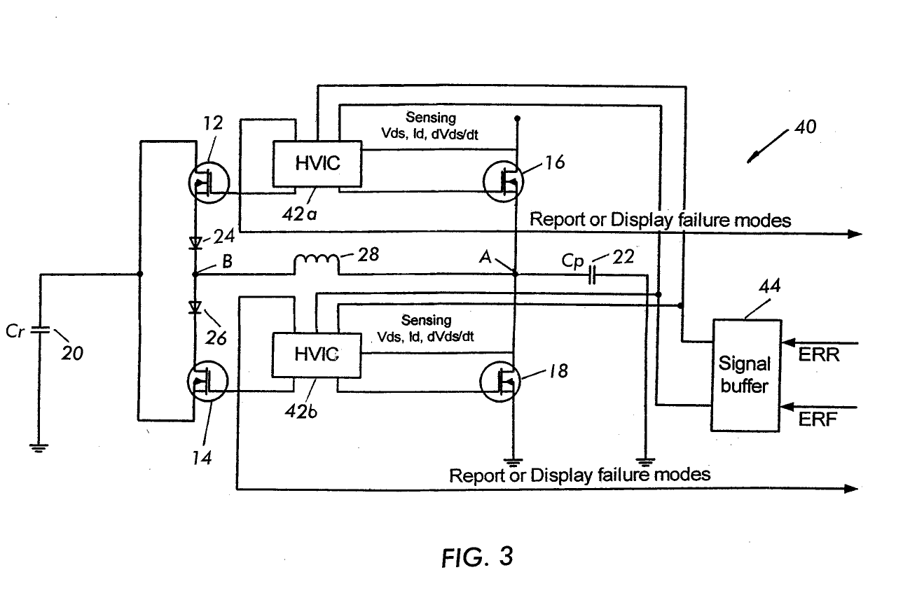

FIG. 3 shows a sustain driver 40 of the present invention that requires only two input signals and uses an HVIC that provides internal diagnostic, protective and reporting functions. The PDP sustain driver 40 includes four switches 12, 14, 16, and 18; capacitor 20 and PDP capacitance 22; diodes 24 and 26 and an inductor 28. The driver 40 is illustrated to include a signal buffer 44 that receives the ERR and ERF signals and includes two HVICs 42a and 42b respectively connected to gates of the switches 12/16 and 14/18. Each HVIC 42a and 42b reports or displays failure modes.

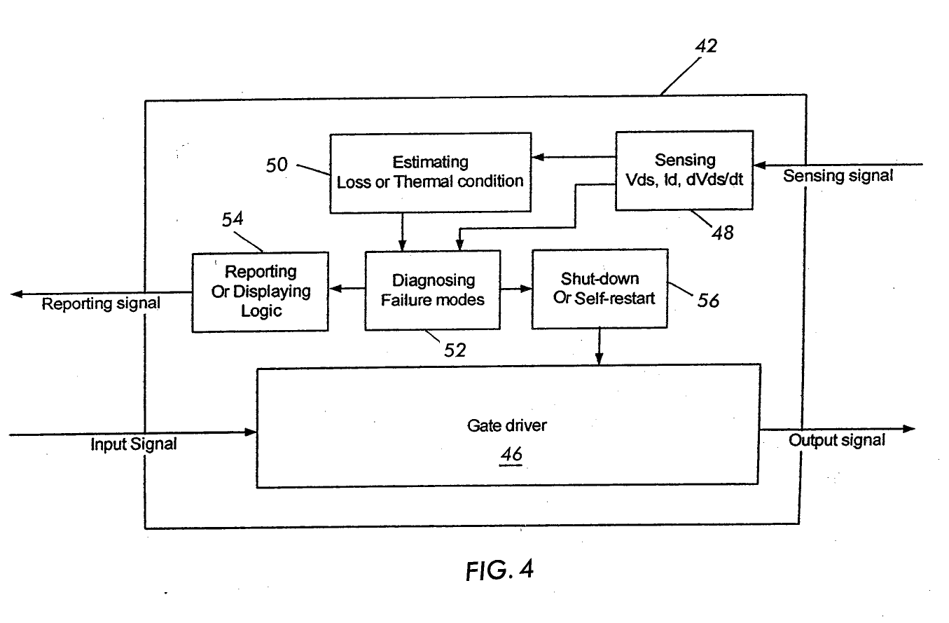

FIG. 4 illustrates the HVIC 42 of the invention that includes internal logic functions. In addition to the two input signals provided by the signal buffer 44 (FIG. 3) to the gate driver 46, the HVIC 42 includes a sensing circuit 48 that senses system information, such as, current or voltage of the switch, variation of the current or variance of the voltage, temperature of the switch, ambient temperature, and similar power information about the switches 16 and 18. The sensed information is provided to an estimating circuit 50 that estimates voltage loss or the thermal condition of the switch and the sensed information, together with the estimating information from the circuit 50 is provided to a diagnosing circuit 52 for diagnosing of the failure modes. The diagnosing circuit 52 then alerts a reporting circuit 54 to report or display a signal indicating a particular failure mode. Additionally, the diagnosing circuit 52 alerts a protection circuit 56 to command the gate driver 46 to shut-down or self restart in accordance with the failure mode.

Accordingly, the system status and failure modes are diagnosed from the sensed information and the information processed in the estimating circuit. When the diagnostic function detects abnormal operation, accidents, and failures, the protection circuit 56 forces the system to shut-down or self-restart to prevent damages and product liability accidents. Also, as stated above, the reporting circuit 54 can report and display the status and failure modes reflecting the diagnostic results to a system controller or debugging engineer.

The present invention makes debugging of system failures easy because failure modes can now be reported to the system controller and the status of failures can be displayed. The operating status of the switches and their sensing of the information can be monitored in order to detect and prevent abnormalities and accidents. Thus, system damage and product liability accidents can be prevented by using the internal HVIC protection functions such as shut-down and self-restart.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A PDP sustain driver circuit including at least one high voltage gate driver IC (HVIC) having internal logic functions, the circuit comprising:
a plurality of electronic switches, the HVIC providing a unique control signal to at least one first and at least one second switch;
the internal logic functions comprising:
a sensing circuit for sensing information about the at least one second switch; and
a reporting circuit for reporting or displaying a signal indicating at least one of a plurality of failure modes of the at least one second switch.

2. The circuit of claim 1, the internal logic functions further comprising
an estimating circuit for receiving the sensed information and estimating a failure condition;
a diagnosing circuit for receiving the sensed information and the estimated failure condition and diagnosing the at least one failure mode; and
a protection circuit for commanding the gate driver to shut-down or self restart in accordance with the failure mode,
wherein the diagnosing circuit alerts the reporting and protection circuits to report or display the failure mode and to issue the shut-down or self restart commands.

3. The circuit of claim 1, wherein the plurality of switches includes rising, falling, sustain, and ground switches, each switch being driven by a unique signal connected to the switch's gate.

4. The circuit of claim 3, wherein the rising and falling switches are coupled in a half-bridge and the sustain and ground switches are coupled in a second half-bridge.

5. The circuit of claim 4, wherein the second half-bridge is integrated in the HVIC.

6. The circuit of claim 2, wherein the estimated failure condition is selected from an estimation of a power loss and a thermal condition of the switch.

7. The circuit of claim 1, wherein the sensing information is selected from a current value, a voltage value, variation of the current value, variance of the voltage value, temperature, and ambient temperature of at least one second switch.

8. The circuit of claim 1, wherein the system information and the at least one failure mode are reported to a system controller.

9. The circuit of claim 1, further comprising a signal buffer for receiving at most two input signals and providing the at most two signals to a gate driver.

10. The circuit of claim 1, wherein the PDP sustain driver is a bridge driver with soft switching for a capacitive load.

11. The circuit of claim 2, wherein the HVIC integrates any two or more circuits selected from the sensing, estimating, diagnostic, reporting, and protecting circuits.

12. The circuit of claim 11, comprising at least two HVICs.
